(19) United States
(12) Patent Application Publication
(10) Pub. No.: US 2010/0001241 A1
(43) Pub. Date: Jan. 7, 2010

(54) Stern Drive Jack Stand

(76) Inventor: Richard W. Rentschler, Griffith, IN (US)

Correspondence Address: COOK ALEX LTD, SUITE 2850, 200 WEST ADAMS STREET, CHICAGO, IL, 60606, US

(21) Appl. No.: 12/167,371

(22) Filed: Jul. 3, 2008

(51) Int. Cl. B66F 5/04

(52) U.S. Cl. 254/2 R

(57) ABSTRACT

A lifting mechanism having a base at least one upright mounted on the base and a pair of support arms mounted for vertical movement along the upright. A jack is provided for lifting and holding the support arms. The jack is supported on a stand which can be supported at various selected positions along the length of the upright.

### BACKGROUND

The lifting mechanism of this disclosure is a relatively inexpensive and simple to manufacture mechanism for lifting and supporting machinery and equipment which otherwise would be difficult for workers to lift and hold in place during maintenance and repair work. An example of a piece of machinery or equipment with which this lifting mechanism may be used is a stern drive on a power boat. Previously available lifting devices which were referred to sometimes as stern drive installers were manufactured of custom designed supporting frames and arms and used heavy hydraulic cylinders having piston rods with long throws. Similar lifting mechanisms are also used as trailer hitch hoists, automobile and truck transmission lifts and manually operated lift trucks for general commercial and industrial use and could be replaced by the lifting mechanism of this disclosure.

### SUMMARY OF THE INVENTION

The lifting mechanism of this disclosure unexpectedly provides a mechanism that is relatively simple to manufacture using stock items that are strong, light and inexpensive in comparison to previously available lift mechanisms. While the mechanism is specifically designed for installing and removing stern drives on boats, it may also be used for other lifting and supporting tasks.

The simplicity of the lift's construction is obtained by using rectangular steel tubing for its base, uprights and lifting arms. The lifting arms are movable through a relatively long range of vertical movement using a hydraulic jack having a piston with a throw that is much shorter than the range of vertical movement of the lifting arms. This unexpectedly long range of vertical movement of the lifting arms using a hydraulic jack with a relatively short piston rod throw is obtained by supporting the hydraulic jack on a platform that can be mounted and secured at selected heights along the lengths of the uprights. The lifting arms are attached to a frame having sleeves which telescope over the uprights on which the hydraulic jack platform is adjustably mounted. An extension of the supporting arms frame is engaged by the piston rod of the jack for raising and lowering of the lifting arms.

### BRIEF DESCRIPTION OF THE DRAWINGS

The lifting device of this disclosure is shown more or less diagrammatically in the following drawings wherein.

FIG. 1 is a perspective view of the lifting device of this disclosure with some parts broken away for clarity of illustration;

FIG. 2 is a front elevational view of the lifting device of FIG. 1 with some parts broken away for clarity of illustration;

FIG. 3 is a side elevational view of the lifting device of FIG. 1;

FIG. 4 is a side elevational view similar to FIG. 3 but showing the jack and its support platform in its lowest position of adjustment; and

FIG. 5 is a top plan view of the lifting mechanism of FIG. 1.

### DESCRIPTION OF THE PREFERRED EMBODIMENT

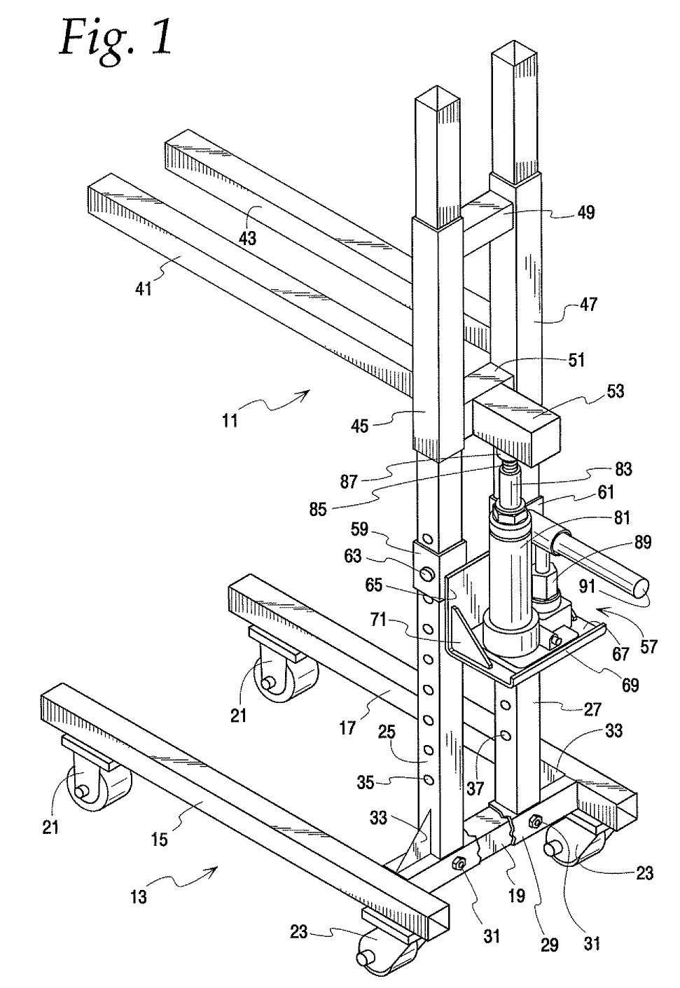

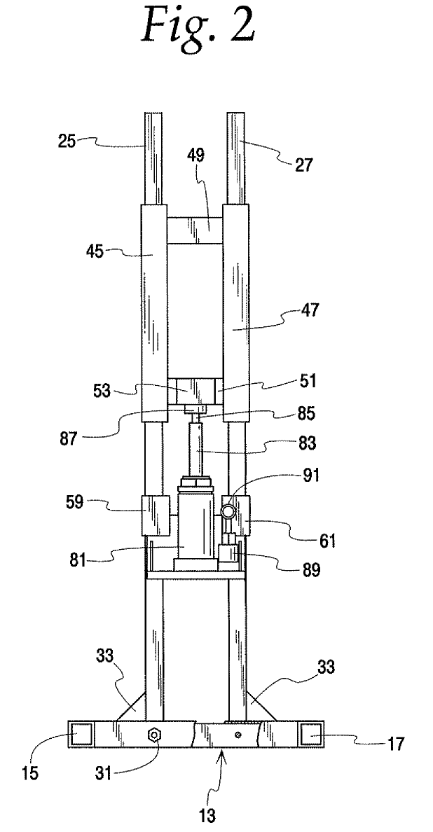

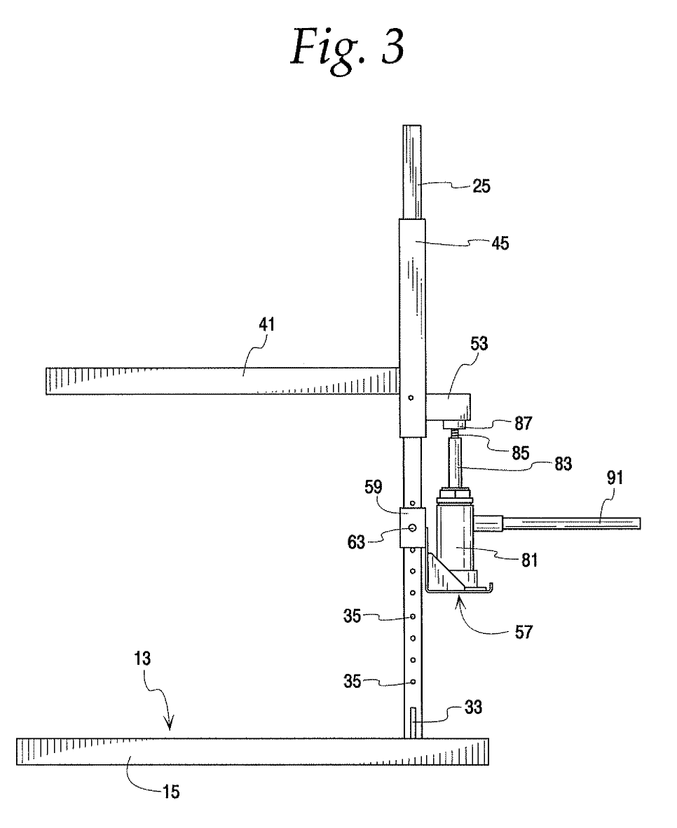

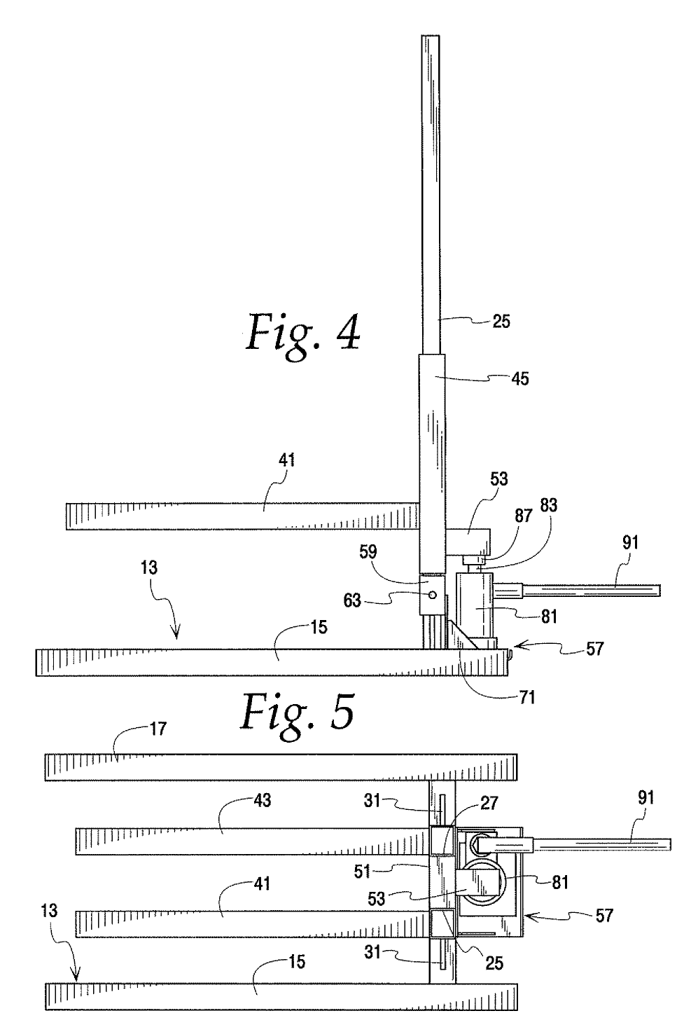

FIG. 1 shows the lifting mechanism 11 of this disclosure in an upper position of elevation. The lifting mechanism includes a base 13 mounted on casters for mobility. The base is formed of a pair of elongated tubular steel members 15 and 17 with a similar tubular cross-member 19 welded to elongated members near the ends thereto to form a U-shaped base. Fixed casters 21 are attached to the tubular members 15, 17 near the open end of the U-shaped base, sometimes referred to as the front end of the lifting mechanism 11, and pivotal casters 23 are attached to the tubular members 15, 17 near the cross-member 19, sometimes referred to as the rear end of the lifting mechanism to provide steerability for the lifting mechanism.

A pair of upright, elongated tubular steel members 25, 27 are welded to an inverted U-shaped channel 29 which fits over and seats on the base cross-member 19. The U-shaped channel 29 is affixed to the base cross-member 19 by threaded fasteners 31 which extend through aligned openings in the channel 29 and cross-member 19 but the openings are not shown for clarity of illustration. Gussets 33 are welded to each of the uprights 25, 27 to provide additional stability for the uprights. Fastener receiving, laterally extending passages 35 and 37 are formed in the uprights 25, 27. These aligned passages are formed in the upright starting near the bottoms of the uprights and extending part way up the heights of the uprights. The aligned passages are uniformly spaced apart along the uprights.

A pair of horizontally extending, elongated lifting and support arms 41, 43 are each attached, as by welding, at adjacent ones of their ends to a tubular sleeve 45, 47, each of which is mounted for sliding vertical movement on an upright 25, 27. The lifting and support arms 41, 43 and the sleeves 45, 47 are formed of tubular steel of generally square cross-section. Square tubular cross-members 49, 51 are welded to the tubular sleeves 45, 47 near the upper and lower ends of the sleeves. A tubular lifting stub arm 53 is fastened to the lower tubular cross-member 51 and extends in a direction away from the support arms 41, 43 when the lifting mechanism 11 is used for lifting and supporting a stern drive of a power boat, the support arms 41, 43 will engage and support the cavitation plate of such a drive.

A jack support stand 57 is attached to tubular sleeves 59, 61 which telescope over and can be moved vertically along the uprights 25, 27 to be secured to the uprights at selected vertical locations. Aligned passages 35, 37 formed in the uprights 25, 27 received threaded fasteners which also extend through additional passages (not shown) in the tubular sleeves 59, 61 to hold the sleeves at selected locations along the vertical heights of the uprights. The jack support stand 57 is somewhat L-shaped in vertical cross-section and can be bent from a suitable sheet of metal. A vertical wall 65 of the jack support stand is welded to the tubular sleeves 59, 61. A base 67 for supporting a jack is formed integrally with the wall 65 with the base having an upturned lip 69 at its outer end. Gussets 71 are welded to the vertical wall and base for strengthening.

A hydraulic jack 81 is supported on the jack support stand 57. While there are various hydraulic jacks that are suitable for use with the lifting mechanism of this disclosure, a hydraulic jack of the type referred as a bottle jack has been found to be particularly suitable. One such suitable hydraulic jack is sold under the tradename “KOBALT” and has a capacity of two tons. As is conventional with bottle jacks, it has a piston rod 83 with relatively short stoke and a threaded rod 85 between the piston rod and its cap 87 to provide incrementally adjustable extension of its piston rod. The cap 87 engages the tubular lifting stub arm 53 to raise and lower the lifting and support arms 41, 43 of the lifting mechanism. An integral pump 89 is formed with the hydraulic cylinder and a pump handle 91 is provided for operating the pump.

Although the lifting mechanism 11 of this disclosure has been shown and described herein with a pair of uprights 25, 27, it should be understood and appreciated that a single upright may be substituted for the pair of uprights. With such a modification, a single sleeve would be used instead of the pair of the sleeves 45, 47 which guide and are connected to the lifting and support arms 41, 43.

1. A lifting mechanism comprising:
a base,
at least one upright mounted on said base,
a pair of support arms mounted for vertical movement along said upright,
a jack for lifting said support arms for vertical movement along said upright, and
a jack support stand mounted on said upright for supporting said jack in selected positions along the length of said upright.

2. The lifting mechanism of claim 1 in which a pair of uprights are mounted on said base.

3. The lifting mechanism of claim 2 in which said support arms are attached to tubular glides which telescope over said uprights.

4. The lifting mechanism of claim 3 in which said tubular glides are connected by upper and lower cross-members and a jack engageable arm extends from one of said cross-members.

5. The lifting mechanism of claim 2 in which said jack support stand is attached to sleeves which are moveable along said uprights and removably attachable to said uprights at selected positions along said uprights.
